(19) United States
(12) Patent Application Publication
(10) Pub. No.: US 2007/0278086 A1
(43) Pub. Date: Dec. 6, 2007

(54) Device and Method for Removing Mercury from Residues

(76) Inventor: Anthonius Hendricus Maria Vermeulen, Deventer (NL)

Correspondence Address: PILLSBURY WINTHROP SHAW PITTMAN, LLP;Eric S. Cherry - Docketing Supervisor, P.O. BOX 10500, MCLEAN, VA, 22102, US

(21) Appl. No.: 10/578,746

(22) PCT Filed: Nov. 12, 2004
(86) PCT No.: PCT/NL04/00796

§ 371 Date: May 10, 2007

(30) Foreign Application Priority Data
Nov. 25, 2003 (NL) 1024862

(51) Int. Cl. B01D 3/34; B01D 3/00

(52) U.S. Cl. 203/49; 202/159; 203/91

(57) ABSTRACT

Device (1) for removing mercury from mercury-containing residues (6), comprising a gastight screw (2) conveyor provided with an inlet (5) for mercury-containing residues (6), first heating means for heating admitted mercury-containing residues and causing mercury to evaporate, an outlet conduit (7) for mercury vapour-containing gas and an outlet channel (10) for mercury-free residues, which device (1) is provided with pump means (16) for applying an underpressure in the screw conveyor (2) and discharging mercury vapour-containing gas therefrom, and with a distillation column (17) provided with cooling means (18, 19) to cause condensation of mercury vapour from the mercury vapour-containing gas discharged with the pump means (16), and a method for removing mercury from mercury-containing residues (16) using this device.

The invention relates to a device for removing mercury from mercury-containing residues, comprising a gastight screw conveyor provided with an inlet for mercury-containing residues, first heating means for heating admitted mercury-containing residues and causing mercury to evaporate, an outlet conduit for mercury vapour-containing gas and an outlet channel for mercury-free residues. The mercury-containing residues come for instance from luminescence tubes, catalyst material, batteries or drilling sludge.

Such a device is known from the Netherlands patent application no. 9100119.

In the known device about 700 m³ of ambient air per hour at a temperature of 20° C. is heated in an air heater to a temperature of about 300° C. and then fed to a heatable screw conveyor into which mercury-containing residues are admitted. Mercury vapour-containing gas having a temperature of about 250° C. is discharged via a vapour discharge and admixed to about 2000 m³ of air with a temperature of 20° C. and about 60 m³ of heated air with a temperature of about 60° C. The thus resulting air-vapour mixture, which has a temperature of about 80° C., is fed to a dust collector and a filter for collecting mercury. In the filter, which consists of active carbon impregnated with sulphur, the mercury is converted to mercury sulphide.

A number of drawbacks are associated with the known device. The mercury in the mercury-containing residues is evaporated at a pressure of 1 atm. in the device. This has the result that large quantities of air have to be heated and transported in order to actually evaporate all the mercury that may be present. The availability of a voluminous installation is required for this purpose with a high energy requirement and pumps with a relatively high pumping capacity, resulting in high operating and investment costs.

Another drawback of working with air at a pressure of 1 atm. is that the device is not inherently safe. If leakage were to occur at some point, air containing mercury vapour can escape from the known device, with all the risks this entails for the health of people present in the immediate vicinity.

A further drawback of the known device is that the mercury released from the residues becomes available in the form of mercury sulphide, a mercury-containing residual material which must be disposed of as chemical waste.

It is an object of the invention to provide a relatively compact device for removing waste from residues, the investment and operating costs of which are relatively low.

It is another object to provide an inherently safe device, wherein the hopefully unlikely occurrence of leakage does not result in the escape of gases containing mercury vapour.

It is a further object to provide a device, using which mercury is recovered from mercury-containing residues and is not bonded to chemical waste for disposal.

These objectives are achieved, and other advantages gained, with a device of the type stated in the preamble, wherein according to the invention the device is provided with pump means for applying an underpressure in the screw conveyor and discharging mercury vapour-containing gas therefrom, and with a distillation column provided with cooling means to cause condensation of mercury vapour from the mercury vapour-containing gas discharged with the pump means.

The applying of an underpressure achieves that mercury vapour released as a result of the heating in the screw conveyor is immediately discharged in safe manner to the distillation column, where the mercury vapour condenses and the mercury is collected in liquid state and thus becomes available for reuse.

In an embodiment the inlet of a device according to the invention comprises an inlet funnel provided with a gastight shut-off valve.

The residues, which are supplied for instance in granular state, are herein poured into the inlet funnel, the shut-off valve of which is opened periodically to admit the residues into the screw conveyor.

The first heating means are preferably adapted to heat the admitted residues to a temperature higher than 350° C., more preferably to a temperature higher than 550° C.

From the vapour pressure table of mercury it can be inferred that the amount of air for heating that is necessary to remove the mercury from contaminated residues which occur in practice and have for instance 0.1% by weight of mercury, at a temperature higher than 350° C. is low in relation to a determined weight quantity of contaminated residues. This applies to an even greater extent at a temperature higher than 550° C., this temperature being above the melting range of many mercury-containing alloys.

In yet another embodiment, the outlet channel for mercury-free residues comprises an outlet sluice provided with two gastight shut-off valves.

Such an outlet channel provides the practical advantage that mercury-free heated residues can be supplied continuously by the screw conveyor into a part of the outlet channel lying between the screw conveyor and the first of the two shut-off valves, where these residues are left to lie and can cool until the part in question is wholly filled, whereafter the said quantity of residues is received in the sluice by opening the first shut-off valve, and can there cool for a subsequent period until the sluice must be cleared for a following quantity of residues.

In a practically advantageous embodiment, the outlet conduit comprises a dust filter for intercepting dust which comes from the residues and which is entrained by the mercury vapour-containing gas.

In order to achieve that the amount of air, even when it cools outside the heated screw conveyor, is sufficient to hold in vapour form the mercury from the residues, and to prevent premature condensation, the device is provided in a preferred embodiment with air inlet means and control means for admitting air for the purpose of receiving therein and discharging mercury vapour, while maintaining the pressure in the device at a predetermined value.

So as to prevent too strong a cooling of the mercury-containing gas outside the screw conveyor, in a device according to the invention the outlet conduit is preferably provided with second heating means for heating the mercury vapour-containing gas.

In another preferred embodiment, the pump means are provided with third heating means for heating the mercury vapour-containing gas.

The second and third heating means are for instance adapted to maintain the temperature of the mercury vapour-containing gas at a value of at least 180° C.

In order to ensure that all mercury vapour from the mercury vapour-containing gas fed into the distillation column condenses therein, the cooling means are adapted to cool the mercury vapour-containing gas to a temperature at least lower than minus 30° C.

The invention further relates to a method for removing mercury from mercury-containing residues using the device described here, comprising the steps of (i) admitting mercury-containing residues into a gastight screw conveyor, (ii) heating the admitted mercury-containing residues and causing mercury to evaporate, (iii) applying an underpressure in the screw conveyor and discharging mercury vapour-containing gas therefrom, (iv) causing mercury vapour to condense from the mercury vapour-containing gas discharged with the pump means, and (v) collecting mercury in condensed state.

The invention will be elucidated hereinbelow on the basis of an exemplary embodiment and with reference to the drawing.

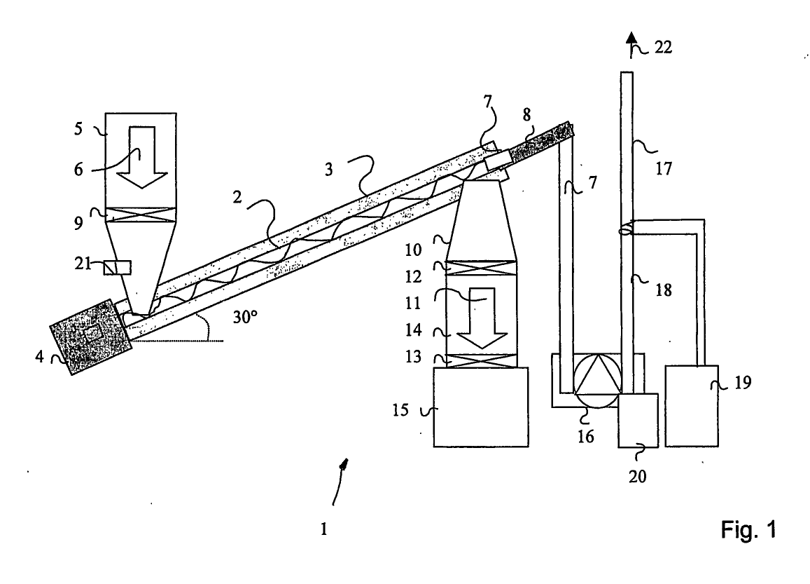

In the drawing FIG. 1 shows a simplified block diagram of an exemplary embodiment of a device 1 according to the invention, with a screw conveyor 2 which is provided with a gastight casing 3 in which heating elements (not shown) are arranged, and which is driven by a motor 4. Screw conveyor 4 is disposed at an angle of 30° to a horizontal plane, is provided on its inlet side (on the left in the figure) with an inlet funnel 5 for granular residues, or at least residues reduced in size, (represented by arrow 6) and is provided on its outlet side (on the right in the figure) with an outlet conduit 7 for mercury vapour-containing gas, with dust filter 8, and an outlet channel 10 for mercury-free residues (represented by arrow 11). Inlet funnel 5 is provided with a gastight shut-off valve 9, outlet channel 10 is provided with two gastight shut-off valves 12, 13, between which a sluice 14 is formed, and debouches above a collecting bin 15. A vacuum pump 16 is connected on its inlet side to outlet conduit 7 and connected on its outlet side to a distillation column 17, which is provided with a Vigreux cooler 18 for pre-cooling the mercury vapour-containing gas to a temperature of about 20° C., and with an intensive cooler 19 for further cooling to a temperature of minus 38° C. A collecting vessel 20 is provided for collecting condensed (liquid) mercury which slides downward along the walls of distillation column 17. In order to prevent mercury condensing prematurely in outlet conduit 7 or pump 16, both of these are provided with heating elements (not shown). In order to maintain the pressure in screw conveyor 2 at a predetermined value in accordance with the specifications of pump 16, the device is provided with pressure sensors (not shown) and inlet funnel 5 is provided below shut-off valve 9 with an electronically operated adjustable air inlet 21. The admittance of sufficient air achieves that the mercury from the residues remains in vapour form even when the mercury vapour-containing air mixture cools outside the heated screw conveyor, and premature condensation is prevented. Although air from the distillation column 17 (represented by arrow 22) is mercury-free, it can if desired be connected via a pipe system to air inlet 21, whereby a closed system is obtained.

In normal operation of device 1, mercury-containing residual material is poured into inlet funnel 5, from where, after opening of shut-off valve 9, it is taken up into screw conveyor 2, where it is heated for a period of about 8 minutes to a temperature of about 560° C., wherein mercury vapour-containing air is drawn off, using a heated vacuum pump 16, via a heated outlet conduit 7 and dust filter 8, wherein the temperature of the mercury vapour-containing air is maintained at about 180° C. The total quantity of residues in the screw conveyor amounts to about 150 kg. After the mercury has been removed, the residues disappear on the outlet side of screw conveyor 2 into an outlet channel 10 and cool there for a time, whereafter the first shut-off valve 12 is opened and residues 11 cool further in a sluice 14. Just before the space in outlet channel 10 above the first shut-off valve 12 is completely filled, the second shut-off valve 13 is opened and the residual material is tipped into collecting bin 15, whereafter sluice 14 is closed once again at its bottom and filled again via its top side. The mercury in the drawn-off air containing mercury vapour condenses in distillation column 17, where it is successively cooled with a Vigreux cooler 18 and an intensive cooler 19 to respectively 20° C. and −38° C., wherein mercury is collected in collecting vessel 20 and air 22 free of mercury vapour is released at the of column 17 or, if desired, admitted again into the ice by way of a closed circuit via air inlet 21 of et funnel 5.

1. Device (1) for removing mercury from mercury-containing residues (6), comprising a gastight screw conveyor (2) provided with an inlet (5) for mercury-containing residues (6), first heating means for heating admitted mercury-containing residues and causing mercury to evaporate, an outlet conduit (7) for mercury vapour-containing gas and an outlet channel (10) for mercury-free residues, characterized in that the device (1) is provided with pump means (16) for applying an underpressure in the screw conveyor (2) and discharging mercury vapour-containing gas therefrom, and with a distillation column (17) provided with cooling means (18, 19) to cause condensation of mercury vapour from the mercury vapour-containing gas discharged with the pump means (16).

2. Device (1) as claimed in claim 1, characterized in that the inlet comprises an inlet funnel (5) provided with a gastight shut-off valve (9).

3. Device (1) as claimed in claims 1-2, characterized in that the first heating means are adapted to heat the admitted residues to a temperature higher than 350° C.

4. Device (1) as claimed in claim 3, characterized in that the first heating means are adapted to heat the admitted residues to a temperature higher than 550° C.

5. Device (1) as claimed in any of the claims 1-4, characterized in that the outlet channel (10) for mercury-free residues comprises an outlet sluice (14) provided with two gastight shut-off valves (12,13).

6. Device (1) as claimed in any of the claims 1-5, characterized in that the outlet conduit (7) comprises a dust filter (8).

7. Device (1) as claimed in any of the claims 1-6, characterized in that it is provided with air inlet means (21) and control means for admitting air for the purpose of receiving therein and discharging mercury vapour.

8. Device (1) as claimed in any of the claims 1-7, characterized in that the outlet conduit (7) is provided with second heating means for heating the mercury vapour-containing gas.

9. Device (1) as claimed in any of the claims 1-8, characterized in that the pump means (16) are provided with third heating means for heating the mercury vapour-containing gas.

10. Device (1) as claimed in claims 8 and 9, characterized in that the second and third heating means are adapted to maintain the temperature of the mercury vapour-containing gas at a value of at least 180° C.

11. Device (1) as claimed in any of the claims 1-10, characterized in that the cooling means (19) are adapted to cool the mercury vapour-containing gas to a temperature at least lower than minus 30° C.

12. Method for removing mercury from mercury-containing residues (6) with a device (1) as claimed in claim 1, comprising the steps of
(i) admitting mercury-containing residues (6) into a gastight screw conveyor (2),
(ii) heating the admitted mercury-containing residues and causing mercury to evaporate,
(iii) applying an underpressure in the screw conveyor (2) and discharging mercury vapour-containing gas therefrom,
(iv) causing mercury vapour to condense from the mercury vapour-containing gas discharged with the pump means (16), and
(v) collecting mercury in condensed state.

13. Method as claimed in claim 11, characterized in that the residues are heated in step (ii) to a temperature of about 560° C.

14. Method as claimed in any of the claims 11-13, characterized in that the underpressure to be applied in step (iii) amounts to about 750 mBar.

15. Method as claimed in any of the claims 11-14, characterized in that the mercury vapour-containing gas to be discharged in step (iii) is guided into a heated conduit (7) in which this gas is held at a temperature of at least 180° C.

16. Method as claimed in any of the claims 11-15, characterized in that the mercury vapour-containing gas to be discharged in step (iv) is guided into a distillation column (17) which is at least partially cooled to a temperature of about minus 38° C.

17. Method as claimed in any of the claims 11-16, characterized in that while maintaining the underpressure to be applied in step (iii) air is admitted into the device (1) in order to entrain mercury vapour.
